(19) United States
(12) Patent Application Publication
(10) Pub. No.: US 2003/0159301 A1
(43) Pub. Date: Aug. 28, 2003

(54) Panel-marking tool and method

(76) Inventor: Brian John George Lawson, Romford (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/286,501

(22) Filed: Nov. 1, 2002

(30) Foreign Application Priority Data
Feb. 23, 2002 (GB) 02 04306.5

(51) Int. Cl. G01D 21/00

(52) U.S. Cl. 33/526

(57) ABSTRACT

A tool for marking a cut line on a panel, which panel is to be fitted into a gap, on a surface, between a pre-fixed panel and an adjacent edge of the surface. The tool comprises a manually-grippable base that defines a marking datum, first and second arms that are mounted on the base for linear sliding movement parallel to each other, and locking means to secure each arm to project from said datum by a preset distance. In use a panel to be marked may be laid between the pre-fixed panel and the adjacent edge, the tool's arms being slid to and locked at a required setting. The tool is then slid along said adjacent edge with the free ends of the arms in contact therewith while the marking datum is used to mark a cut line on the panel to be cut.

### BACKGROUND OF THE INVENTION

1.Field of the Invention

This invention relates to a tool for marking a cut line on a panel to be fitted on to a floor or wall, and to a method of marking a cut line on a panel using such a tool. The invention further relates to a method of marking and fitting a panel to a surface.

2. Description of the Prior Art

The term “panel” is used herein to refer to any distinct constructional element in a sequence of like elements, as applied to a floor, wall or other surface. The term thus encompasses floorboards, tiles, and any other constructional elements intended for use in a sequence of like elements. The term “surface” as used herein encompasses walls, ceilings, worktops and floors, and notional as well as actual surfaces. The term thus encompasses floors even where no actual surface exists prior to the affixing of floorboards thereto, i.e. where the floorboards are to be laid directly onto joists.

When fitting a sequence of such panels to a surface, one is usually presented with a situation where the dimensions of the area to be covered are not exact multiples of the dimensions of the panels being used. The final or edge panel must therefore be cut to size, in order to fit into the gap between the penultimate panel and an adjacent edge of the surface. This necessarily involves a preliminary step of profiling the panel, that is to say marking a cut line which will result in the cut panel being the correct size and shape to fit the gap.

In rare instances where the adjacent edge of the floor or wall is perfectly straight and parallel with the edge of the penultimate panel, this can be accomplished simply with the use of a tape measure and a straight edge such as a ruler. However, if there are variations in the distance between the edge of the penultimate panel and the adjacent edge of the surface, then this method is not viable.

Another traditional solution involves fixing the penultimate panel to the surface, and then placing a second like panel on top thereof. A third like panel is then placed against the adjacent edge of the surface, overlapping the second panel, and a cut line is marked on the second panel using the side of the third panel as a marking datum. However, this method also cannot take account of non-linear variations in the profile of the surface edge, and furthermore is unreliable and awkward, as it requires both the second and third panels to be held accurately in place, usually manually, during marking.

There is therefore a need for a device and method which enables marking of the final panel, whilst taking into account variations in the adjacent edge of the surface.

### SUMMARY OF THE INVENTION

Brief Description of the Present Invention

The present invention provides a tool for marking a cut line on a panel to be fitted on to a surface into a gap between a pre-fixed panel and an adjacent edge of the surface, which tool comprises a manually-grippable base defining a marking datum, first and second arms mounted on the base for linear sliding movement parallel to one another, and locking means to secure each arm to project from said datum by a preset distance, whereby in use a panel to be marked is laid between the pre-fixed panel and the adjacent edge, the arms are slid to and locked at a required setting, and the tool is slid along said adjacent edge with the free ends of the arms in contact therewith while the marking datum is used to mark a cut line on the panel to be cut.

The tool must be capable of smoothly sliding over a panel when in use. This may be achieved by any suitable means such as runners or rollers. However for ease of construction it is currently preferred that the sliding means be no more than the provision of a smooth flat underside on the base.

Similarly, the marking datum may be no more than a rectilinear edge parallel to the direction in which the tool travels during use. A marking implement may then be run along this edge in order to mark the panel. Alternatively, a holder for a marking implement may be provided integrally with the base. The tool may also include a marking device such as a pencil.

The arms extend from the base in a direction perpendicular to that in which the tool travels during use. In a currently preferred embodiment of the invention, the arms are slideable along channels defined in the base, and may be provided with graduated markings along their length. It is currently preferred that the first and second arms should each have a length of substantially 200 mm. A further pair of arms, each having a length of substantially 450 mm may also be provided, said further pair being interchangeable with the first and second arms.

In an alternative embodiment of the present invention, the tool may be provided with more than two arms, thus enabling the user to take account of interruptions in the profile of the surface edge. This embodiment would be particularly useful where the profile of a floor edge is interrupted by upstanding water or heating pipes etc.

The arms are provided with locking means, which preferably comprise a securing nut associated with each channel. These securing nuts are preferably in the form of wing nuts.

In a still further preferred embodiment of the present invention, the tool is provided with a handle integral with the base, thus facilitating the movement of the tool over the panel.

The present invention also provides a method of marking a cut line on a panel to be fitted on to a floor or wall into a gap between a pre-fixed panel and an adjacent edge of the floor or wall using a tool as hereinbefore described, which method comprises laying the panel to be marked between the pre-fixed panel and the adjacent edge, sliding the arms to and locking them at a required setting, and sliding the tool along the adjacent edge with the free ends of the arms in contact therewith whilst using the marking datum to mark a cut line on the panel to be cut.

The present invention further provides a method of fitting a panel into a gap on a surface between a pre-fixed panel already affixed to said surface and an adjacent edge of the surface, which method comprise the steps of:

aligning a first panel to be marked in the gap between the pre-fixed panel and the adjacent edge, and against the pre-fixed panel;

placing on the first panel a marking tool which provides a marking datum, and setting the marking datum at an appropriate distance relative to the adjacent edge;

sliding the marking tool along the first panel using the marking datum to define a cut line on the first panel;

profiling the first panel by cutting it along the cut line and discarding the region between the cut line and the adjacent edge;

moving the first panel from its position adjacent the prefixed panel to a position adjacent the edge;

placing an un-profiled second panel in the space defined between the pre-fixed panel and the first panel; and

fixing the first and second panels in place.

Instead of placing an un-profiled second panel in the space defined between the pre-fixed panel and the first panel, the second panel may be placed against the pre-fixed first panel with the profiled first panel then being located in the remaining gap.

### BRIEF DESCRIPTION OF THE DRAWINGS

In order that the present invention may be better understood, specific embodiments thereof will now be described in detail, though only by way of example, with reference to the following drawings, in which:

FIG. 1 is a front view of a tool according to the present invention;

FIG. 2 is a plan view of the tool of FIG. 1;

FIG. 3 is a side view of the tool of FIGS. 1 and 2;

FIG. 4 is a perspective view of the tool of FIGS. 1 to 3; and

FIG. 5 is sequence of side views showing the tool of FIGS. 1 to 4 in use in a process of marking, cutting and fitting a panel.

### DETAILED DESCRIPTION OF THE PRESENT INVENTION

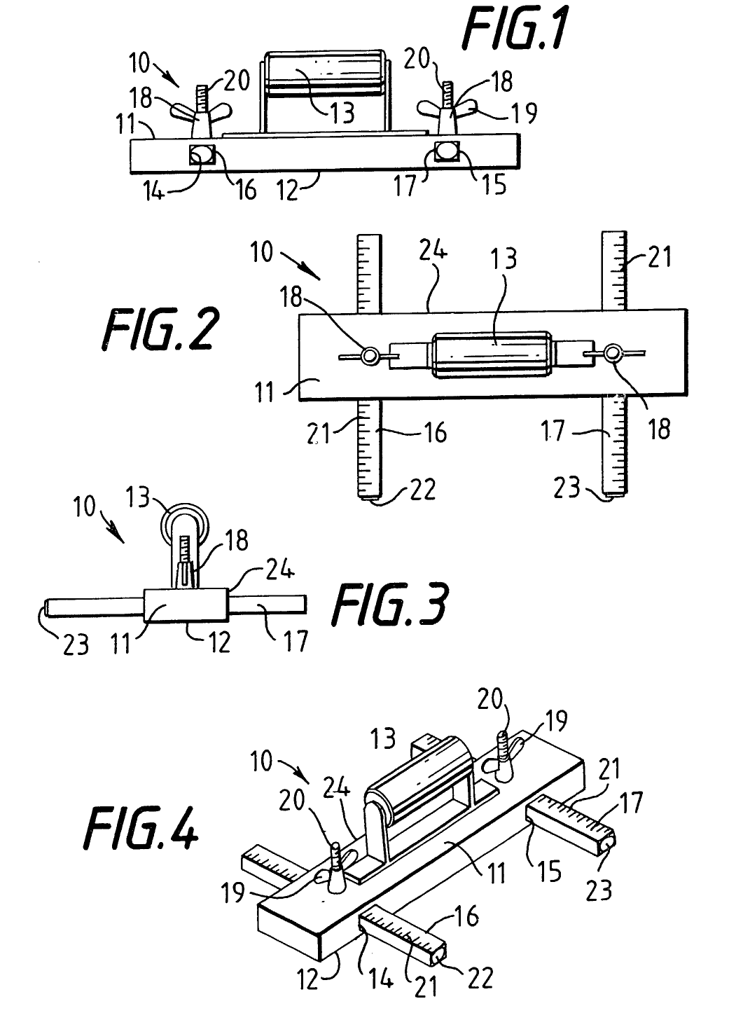

Referring first to FIGS. 1 to 4, there is a shown a tool, generally indicated 10, having a base 11 with a smooth flat underside 12, which facilitates sliding movement over a panel (not shown). A manually-grippable handle 13 is mounted on the base 11, which handle 13 allows a user to control the sliding motion of the tool 10 over the panel.

First and second channels 14, 15 are defined in the base 11, extending therethrough. First and second arms 16, 17 are mounted in the first and second channels 14, 15 respectively, and are slideable therealong. Locking means 18 each comprising a wing nut 19 rotatable on a threaded shaft 20 are associated with each of the first and second channels 14, 15. These are adapted to secure the first and second arms 16, 17 at a desired extension from the base 11, the degree of which extension may be shown by graduated markings 21 provided on each of the first and second arms 16, 17.

The free ends 22, 23 of the first and second arms 16, 17 are adapted to bear against a raised margin at or adjacent the edge of the surface to be covered (not shown in FIGS. 1 to 4). In practice, when marking a panel to be fixed to a floor, the “margin” will in fact usually be a lower part of a wall up to which the floor extends. The side of the base 11 distal from said free ends 22, 23 forms a marking edge 24.

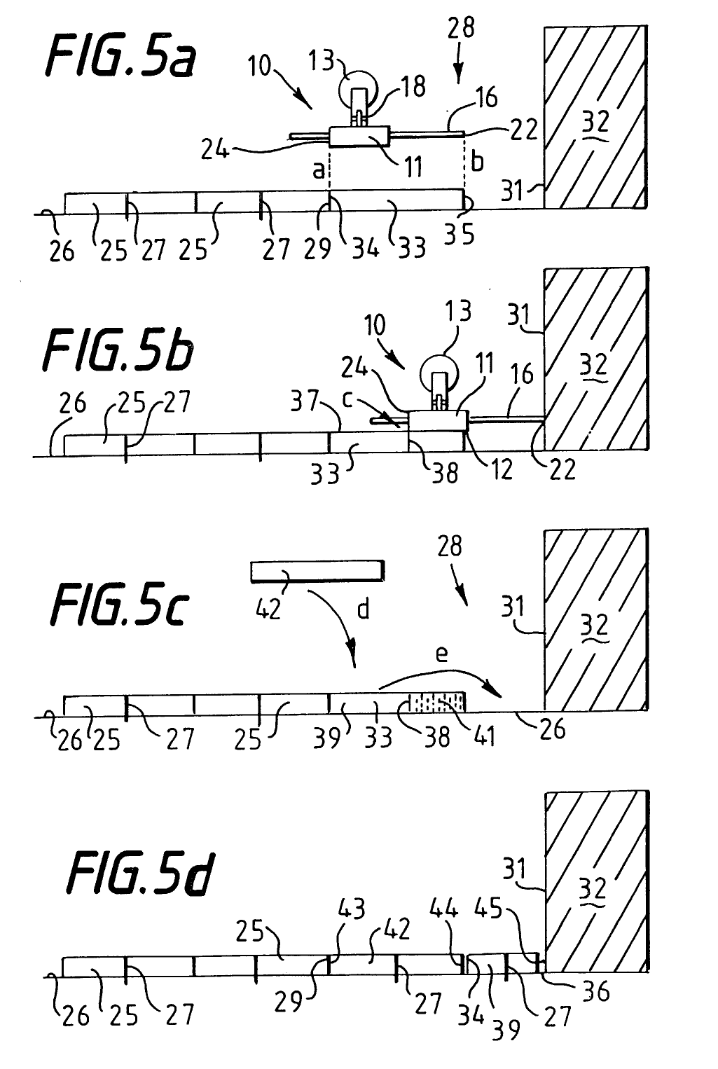

Use of the tool 10 for the marking of a panel in a process of fitting panels (floorboards in this example) to a floor will now be described with reference to FIGS. 5a to 5d.

Referring first to FIG. 5a, there is shown a sequence of prefixed floorboards 25, which are fixed to a floor 26 by fixing means, such as nails 27. A gap, generally indicated 28, extends between the edge 29 of the last pre-fixed floorboard 25 in the sequence and an adjacent edge 31 of a wall 32. The gap 28 is clearly larger than the width of a floorboard 25, but smaller than the width of two such floorboards 25.

A first free floorboard 33, of equal dimensions to the pre-fixed floorboards 25 is laid in the gap 28 such that one edge 34 of the free floorboard 33 abuts against the edge 29 of the last pre-fixed floorboard 25 in the sequence. The tool 10 is then placed over the first free floorboard 33 and aligned therewith such that the marking edge 24 on the base 11, is aligned with the edge 29 of the last prefixed floorboard 25, as indicated by dotted line a. The locking means 18 are then released to allow the first and second arms 16, 17 to slide freely within their respective channels 14, 15, until the free ends 22, 23 of the arms 16, 17 are aligned with the other edge 35 of the free floorboard 33, as indicated by dotted line b. If desired, the first and second arms 16, 17 may be extended slightly further so as to allow for an expansion gap 36 (as shown in FIG. 5d) in the finished floorboard sequence, and this further extension may be controlled by the use of the graduated markings 21. The locking means 18 are then tightened so as to secure the first and second arms 16, 17 at the desired extension from the base 11.

As is shown in FIG. 5b, the tool 10 is then placed onto the free floorboard 33 such that the flat underside 12 of the base 11 rests on the upper surface 37 of the floorboard 33. The tool 10 is then positioned such that the free ends 22, 23 of first and second arms 16, 17 abut against the adjacent edge 31 of the wall 32. Using the handle 13, the tool 10 is then slid over the floorboard 33 in a direction parallel to the edge 31 of the wall 32 (i.e. perpendicular to the plane of the page in FIG. 5b). At the same time a marking tool such as a pen or pencil, indicated by arrow c, is run along the marking edge 24 where it meets the upper surface 37 of the floorboard 33 so as to mark a cut line 38 thereon.

Referring now to FIG. 5c, the cut line 38 effectively divides the floorboard 33, into a working section 39 and a waste section 41. The first free floorboard 33 is then removed from its location adjacent the pre-fixed floorboards 25, and replaced with a second like free floorboard 42, as indicated by arrow d. After the first free floorboard 33 has been cut along the cut line 38, the waste section 41 is discarded, and the working section 39 is returned to the gap 28 as indicated by arrow e.

As shown in FIG. 5d, the second free floorboard 42 is laid in the gap 28 such that one edge 43 of said second free floorboard 42 abuts against the edge 29 of the pre-fixed floorboard 25. The working section 39 of the first free floorboard 33 is laid in the remainder of the gap 28 such that the one edge 34 of the working section 39 abuts against the other edge 44 of the second free floorboard. An expansion gap 36 remains between the other edge 45 of the working section 39 and adjacent edge 31 of the wall 32. The second floorboard 42 and the working section 39 may then be fixed to the floor 26 by nails 27.

What is claimed is:

1. A tool for marking a cut line on a panel to be fitted on to a surface into a gap between a pre-fixed panel and an adjacent edge of the surface, which tool comprises a manually-grippable base defining a marking datum, first and second arms mounted on the base for linear sliding movement parallel to one another, and locking means to secure each arm to project from said datum by a preset distance, whereby in use a panel to be marked is laid between the pre-fixed panel and the adjacent edge, the arms are slid to and locked at a required setting, and the tool is slid along said adjacent edge with the free ends of the arms in contact therewith while the marking datum is used to mark a cut line on the panel to be cut.

2. A tool as claimed in claim 1, wherein the base has a smooth flat underside so as to facilitate sliding movement over a panel.

3. A tool as claimed in claim 1, wherein the marking datum comprises a rectilinear edge parallel to the direction in which the tool travels when in use.

4. A tool as claimed in claim 1, comprising more than two arms.

5. A tool as claimed in claim 1, wherein channels are defined in the base and the arms are slideable therein.

6. A tool as claimed in claim 1, wherein the arms extend from the base in a direction perpendicular to the direction in which the tool travels when in use.

7. A tool as claimed in claim 1, wherein the arms are provided with graduated markings along their length.

8. A tool as claimed in claim 5, wherein the locking means comprise a securing nut associated with each channel.

9. A tool as claimed in claim 8 wherein the securing nut is a wing nut.

10. A tool as claimed in claim 1, further comprising a handle integral with the base.

11. A tool as claimed in claim 1, wherein the first and second arms each have a length of about 200 mm.

12. A tool as claimed in claim 11 wherein there is provided a further pair of arms, each having a length of about 450 mm, said further pair of arms being interchangeable with the first and second arms.

13. A method of marking a cut line on a panel to be fitted on to a surface into a gap between a pre-fixed panel and an adjacent edge of the surface using a tool as claimed in claim 1, which method comprises laying the panel to be marked between the pre-fixed panel and the adjacent edge, sliding the arms to and locking them at a required setting, and sliding the tool along the adjacent edge with the free ends of the arms in contact therewith whilst using the marking datum to mark a cut line on the panel to be cut.

14. A method of fitting a panel into a gap on a surface between a pre-fixed panel already affixed to said surface and an adjacent edge of the surface, which method comprise the steps of:
aligning a first panel to be marked in the gap between the pre-fixed panel and the adjacent edge, and against the pre-fixed panel;
placing on the first panel a marking tool which provides a marking datum, and setting the marking datum at an appropriate distance relative to the adjacent edge;
sliding the marking tool along the first panel using the marking datum to define a cut line on the first panel;
profiling the first panel by cutting it along the cut line and discarding the region between the cut line and the adjacent edge;
moving the first panel from its position adjacent the prefixed panel to a position adjacent the edge;
placing an un-profiled second panel in the space defined between the pre-fixed panel and the first panel; and
fixing the first and second panels in place.
